(19) United States
(12) Patent Application Publication
(10) Pub. No.: US 2005/0078701 A1
(43) Pub. Date: Apr. 14, 2005

(54) Network interface device and housing

(76) Inventor: Douglas A. Atkinson, Ashburn, VA (US)

Correspondence Address: KEVIN A. BUFORD;HOLLAND & KNIGHT LLP, 1600 TYSONS BOULEVARD, SUITE 700, MCLEAN, VA, 22102, US

(21) Appl. No.: 10/938,894

(22) Filed: Sep. 10, 2004

Related U.S. Application Data
(60) Provisional application No. 60/502,559, filed on Sep. 12, 2003.

(51) Int. Cl. H04L 12/66

(52) U.S. Cl. 370/463

(57) ABSTRACT

In a preferred embodiment, a method and apparatus are disclosed for providing a universal mounting plate and a snap on B-NID (Broadband NID) that allows an installer to use the same mount location as the previous NID. The B-NID mounting plate is preferably symmetrical in orientation, with plural through holes for feeding cables from the network termination into the home through the mounting plate, and plural holes for attaching the mounting plate to a wall or similar structure. Convenient wire storage structures, and quick attachments for the cover are also provided. The B-NID cover includes two doors, one for carrier access to network termination unit, and the second for customer access. It also has complementary attachment points for receiving and firmly securing the mounting plate quick attachments.

### FIELD OF THE INVENTION

The invention in general relates to the field of electronics interfaces, and more particularly to broadband network interface devices.

### BACKGROUND

One of the key challenges in the communications industry today is how to provide a cost effective, broadband solution for getting multiple services, such as telephony, video, and high speed data, to users in such diverse premises as homes and business buildings. Because of the superior bandwidth of fiber optic solutions, a variety of systems have been proposed to provide fiber to the home/business (FTTH/B) as the best overall solution for broadband services. Other broadband solutions include digital subscriber loop (DSL) technologies and cable television (CATV) systems delivering digital and video data via coaxial cable.

Leading solutions for FTTH/B rely on passive optical networks (PONs), in which the optical network is terminated at the premises in some form of optical network terminator (ONTs). Other broadband systems rely on other type of network terminations (NT), mostly active. However, two key problems are present in today's solutions for coupling the broadband networks, via NTs, to the local premises network. These existing solutions typically involve some form of customized cabling for linking the two networks. This happens because there are several different types of cabling found in premises today.

A second concern is how to cost effectively manage the point of interface between a premises network and the broader public network. Back when there was one telephone company in each nation, such as the AT&T in the U.S. before its break up in 1984, that company usually set standards for the interface panels deployed on the side of houses and other buildings. A relatively standard panel can still be found on the side of each house in the U.S. that has phone services. However, with the advent of broadband services like DSL (digital subscriber line) and cable modems, the prior art interface units no longer suffice for the larger interface units needed for broadband services.

Thus, as new broadband platforms are deployed, the existing telephone company supplied passive network interface devices (NID) will need to be removed an and replaced with a new active device for terminating broadband signals. However, by removing the old NID, the attachment points are exposed. If left exposed, these become a possible location for water, etc. to enter the interior of the building. Alternatively, the point of ingress can be sealed by the technician, but this takes more time and expense, while leaving a potentially unsightly patch on the house wall.

There remains, therefore, a need for a quick, cost efficient means to replace old NID units with units capable of supporting broadband service interfaces. Just such a solution to the problems noted above and more, are made possible by my invention disclosed here.

### SUMMARY

This invention, while defined by the claims, may be better understood by reference to the embodiments described below, of which the following is a brief summary. In a preferred embodiment, a method and apparatus are disclosed for providing a universal mounting plate and a snap on B-NID (Broadband NID) that allows an installer to use the same mount location as the previous NID. The B-NID mounting plate is preferably symmetrical in orientation, with plural through holes for feeding cables from the network termination into the home through the mounting plate, and plural holes for attaching the mounting plate to a wall or similar structure. Convenient wire storage structures, and quick attachments for the cover are also provided. The B-NID cover includes two doors, one for carrier access to the network termination unit, and the second for customer access. It also has complementary attachment points for receiving and firmly securing the mounting plate quick attachments. By using this B-NID, the installation process is eased by, e.g., not requiring technicians to drill new mounting locations or fill current holes (e.g., with screws or bolts, etc.) to avoid an open entry point (e.g., for water) to the premises. The easy snap-on cover with secure attachments also permits quick, less expensive installation while also providing a cover to the screws or bolts, making theft more difficult.

### THE FIGURES

My invention may be more readily appreciated from the following detailed description, when read in conjunction with the accompanying drawings, in which:

FIGS. 1A-1A are illustrative views of a first embodiment of a two piece B-NID housing in accordance with a first embodiment of the invention, in which:

FIG. 1A is a side view of a universal mount and spool base;

FIG. 1B is a front view of the base of FIG. 1A;

FIG. 1C is a front view of a B-NID cover for the base of FIG. 1A;

FIGS. 2A-2D are illustrative views of a second, preferred embodiment of a two piece B-NID housing, in which:

FIG. 2A is a right side perspective view of a B-NID cover for the housing;

FIG. 2B is a right side perspective view of a B-NID base for use with the housing of FIG. 2A;

FIG. 2C is a right side perspective view of a B-NID housing with the cover of FIG. 2B attached to the base of FIG. 2A; and

FIG. 2D is a side view of the B-NID housing of FIG. 2C.

### DESCRIPTION OF AN EMBODIMENT OF THE INVENTION

These limitations of prior NIDs are overcome by the present invention. In a preferred embodiment, an improved broadband NID is provided in which all of the required components of a broadband NID can be easily installed, quickly replacing old NIDs and connecting the wide area and premises broadband networks. The preferred B-NID has three parts, a base and network termination unit, and a cover.

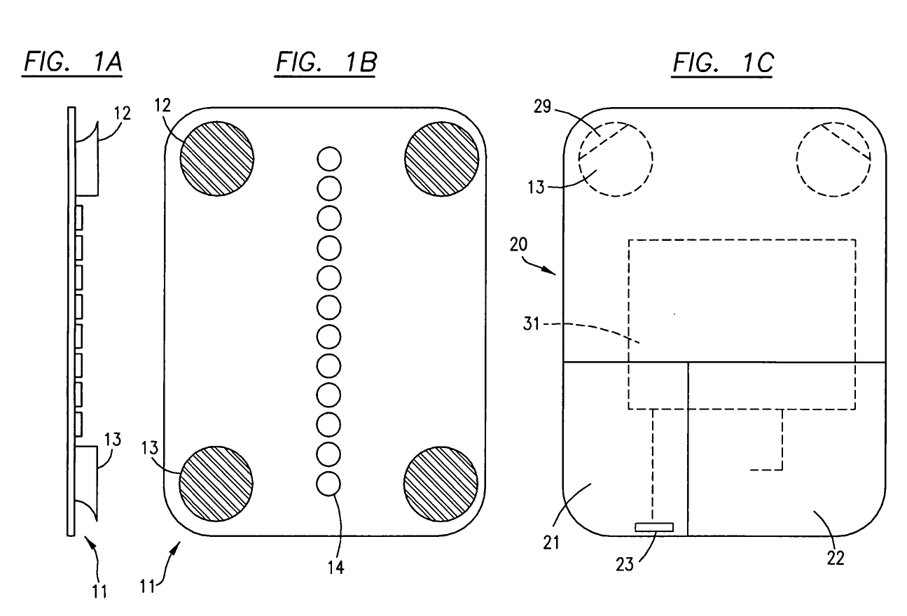

This invention may be better understood by considering the illustrative drawing of the first embodiment, shown in FIGS. 1A-1C. The premises may be any type of residential dwelling or business building or group of buildings, in which a local network solution is implemented and needs to be coupled to an external network. In the illustrated case the external network is an optical distribution network such as a passive optical network (PON) implementing a fiber to the home/building (FTTH/B) architecture. The fiber optic PON is terminated in a network terminating (NT) device 31 such as an optical network terminator (ONT), which may be installed either externally to the premises or inside in a wall mount. In the preferred embodiment, the external network line (e.g., an optical line) is coupled via an appropriate port 23 (e.g., RJ-45) to the NT 31, while the premises network line (e.g., an ethernet line) 14 is coupled via another port of NT 31. An example of an NT is the V-182 ONT from Vinci Systems of Vienna, Va. USA. A skilled artisan will appreciate that other forms of wiring and protocols may be readily implemented for alternative premises networking solutions, via other types of broadband NT devices, both active and passive.

In order to streamline installation, the B-NID 10 is provided with a quick attachment mount 11. This base includes a number of predetermined through-holes 14, designed for use in securing the base 12 with screws or the like to a variety of preexisting screw patterns (as determined by prior NIDs)/holes in the wall. Also part of the mount 11 are plural spool connectors 13, which include a guide feature or channel to hold any excess cable (e.g., fiber, copper, coax) on the spools 13, without exceeding minimum bend radii for the cable.

The cover 20 includes complementary lips 29 for rigidly snap mating to connectors 13. This allows a quick connection, while also inhibiting removal of the B-NID without special tools or breaking the connectors 13. Because the cable connectors to the NT 31 are preferably underneath the cover 20, two access panels or doors are provided, carrier access panel 21 and premises/customer access panel 22. Alternatively, a connector 23 from the NT can be provided on the edge of the cover 20, with a lead from connector 23 to the NT. This is a matter of design choice, as is the type of connection made from the NT to the cover (or alternatively, to the base). If the B-NID is being attached externally, a weather strip (not shown) may also be used to help reduce any exposure of the NT to rain or other elements.

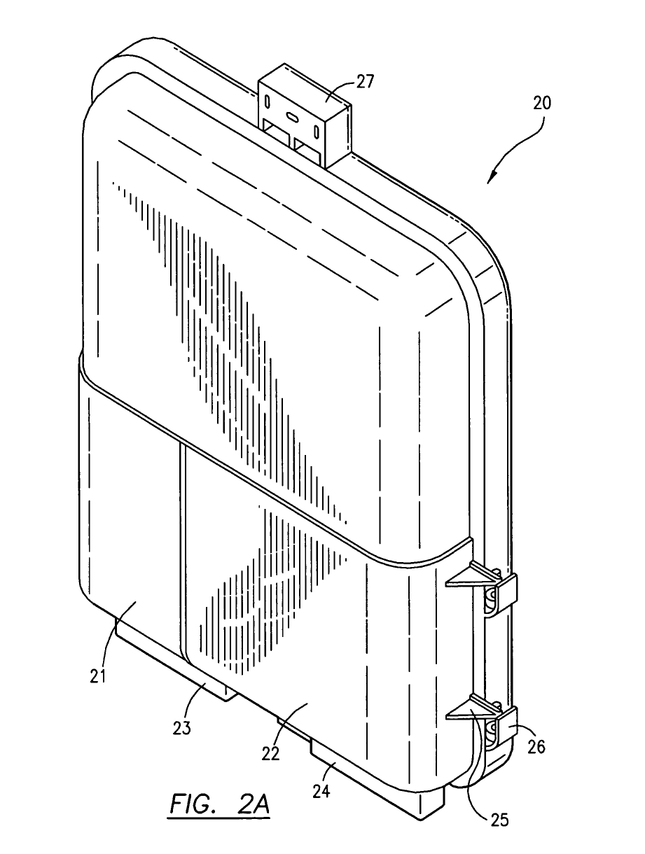

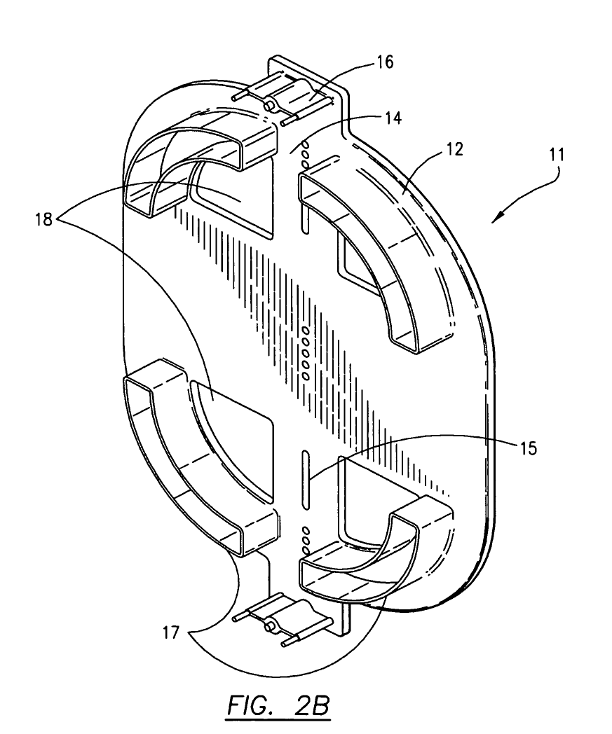

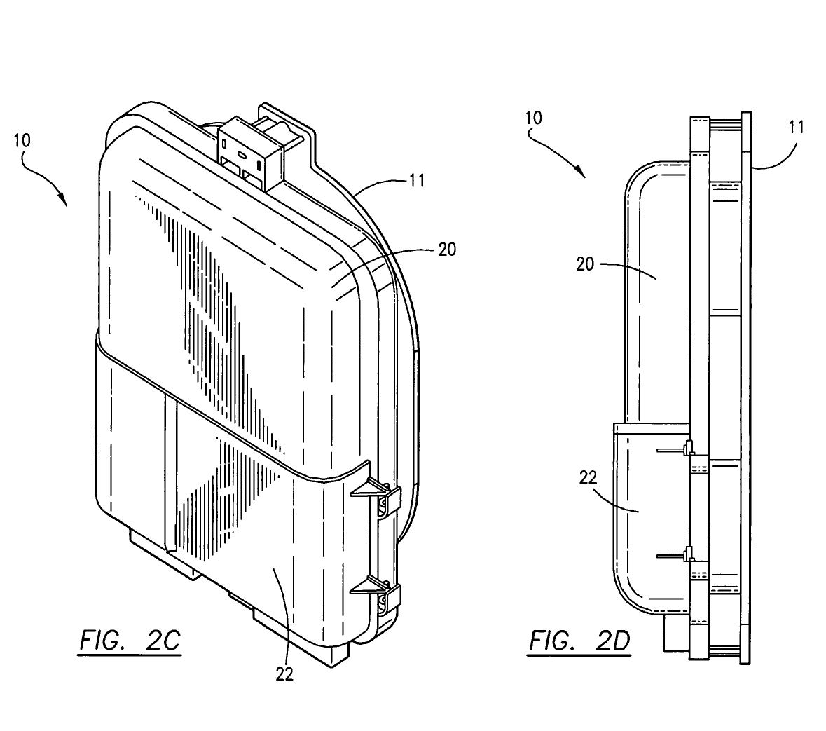

A second, presently preferred embodiment of a B-NID 10 is shown in FIGS. 2A-2D. Instead of having an integrated spool/connector structure, this B-NID uses specialized male 16—female 27 connectors to quickly secure the cover 20 to the mount 11. Multiple patterns of through holes 14 and slots 15 enhance the ability to use existing NID mounting holes or elements to secure the base 11 to a wall. Channels 17 are longer than spool connectors 13, better protecting the minimum radius bend for cables. Additional through holes 18 may also be used for passing the cable through mount 11 into the wall, while keeping the premises ingress hole underneath the cover 20.

The access doors 21, 22 of cover 20 both include latches 25 or similar feature for keeping the access doors closed (e.g., snapped into catch 26). In lieu of connectors on the cover 20, through passages 23, 24 may be provided to guide the external and premises cables, respectively, through the cover to the NT. Hinges (not shown) or other bending member is provided to allow each door to rotate open and closed by the carrier technician or customer. A locking device (e.g., a special locking latch) may also be provided for the carrier door, so only carrier personnel get access to the externally terminating portions of the NT under the carrier access door 21.

Of course, one skilled in the art will appreciate how a variety of alternatives are possible for the individual elements, and their arrangement, described above, while still falling within the spirit of my invention. Thus, for example, additional access panels may be provided (e.g., if multi-customer premises), and materials other than plastics may be used for the base 11 and/or cover 20.

While the above describes several embodiments of the invention used primarily in connection with an improved network interface device/housing, those skilled in the art will appreciate that there are a number of alternatives, based on system and production design choices, that still fall within the spirit of my invention. Thus, it is to be understood that the invention is not limited to the embodiments described above, and that in light of the present disclosure, various other embodiments should be apparent to persons skilled in the art. Accordingly, it is intended that the invention not be limited to the specific illustrative embodiments but be interpreted within the full spirit and scope of the appended claims.

1. A broadband network interface device (B-NID), for connecting a premises network to an external data network, comprising:
a universal mount plate having a spooling device for storing cable being coupled to a first network termination device, and cover connectors;
a cover, comprising the first network termination device, a housing attached to the first network termination device, the housing comprising mount connectors for secure attachment to the cover connectors and an access door for personnel access to a cable connection of the first network termination device.

2. The B-NID of claim 1, wherein the universal mount plate further comprises a pattern of through holes for attachment of the plate to a wall via at least one attachment feature from a prior installed premises network interface device.

3. The B-NID of claim 2, wherein the spooling device comprises plural spooling units each with an outward wall for receiving the cable with no less than a predetermined minimum bend radius.

4. The B-NID of claim 3, wherein the spooling device comprises more than three spooling units.

5. The B-NID of claim 3, wherein the cover connectors are part of the spooling device comprising a snap fitting for receiving the mount connectors and securely attaching the mount connectors in a manner requiring a disengagement tool to separate the mount connectors from corresponding of the cover connectors without structurally damaging at least one of the cover connectors or mount connectors.

6. The B-NID of claim 3, wherein the cover connectors are part of the spooling device comprising a snap fitting for receiving the mount connectors and securely attaching the mount connectors in a manner requiring structural damage to at least one of the cover connectors or mount connectors to separate the mount connectors from corresponding of the cover connectors.

7. The B-NID of claim 1, wherein each cover connectors further comprises a snap fitting for receiving one of the mount connectors and securely attaching said one mount connector in a manner requiring a disengagement tool to separate the mount connectors from corresponding of the cover connectors without structurally damaging at least one of the cover connectors or mount connectors.

8. The B-NID of claim 1, wherein the access door is a carrier access door for access to the cable connection for receiving an external network cable, the cover further comprising a premises access door for personnel access to a further cable connection for receiving a premises network cable.

9. The B-NID of claim 8, wherein the cover further comprises a threaded fiber cable connector for rapid connection of the external network cabling.
